(19) United States
(12) Patent Application Publication
(10) Pub. No.: US 2003/0016635 A1
(43) Pub. Date: Jan. 23, 2003

(54) Method and apparatus for reducing co-channel interference in a wireless downlink

(76) Inventors: Michael R. Andrews, Summit, NJ (US); Anirvan Mayukn Sengupta, warren, NJ (US); Boris I. Shraiman, Springfield, NJ (US)

Correspondence Address: HARNESS, DICKEY & PIERCE, P.L.C., P.O. Box 8910, Reston, VA, 20195, US

(21) Appl. No.: 10/183,377

(22) Filed: Jun. 28, 2002

Related U.S. Application Data
(60) Provisional application No. 60/303,909, filed on Jul. 10, 2001.

(51) Int. Cl. H04Q 7/00

(52) U.S. Cl. 370/328; 455/422

(57) ABSTRACT

Base stations transmit corresponding pilot signals identifiable with the corresponding base station, parameters associated with the pilot signals are measured at mobile stations and transmitted back to the base stations on an uplink channel. The measured parameters are shared between the base stations over a separate network. Co-channel transmissions are formulated at the base stations using the measured parameters, such that at least two mobile stations receive respective transmissions on the same channel. Adaptation of the transmission to the changes in propagation reduces co-channel interference. The wireless network is one of a CDMA and a FDMA network.

### RELATED APPLICATION

This application claims benefit of U.S. Provisional Patent Application Serial No. 60/303,999, filed in the USPTO on Jul. 9, 2001, the entire contents of which are hereby incorporated by reference.

### BACKGROUND OF THE INVENTION

1. Field of the Invention

The present invention is related to increasing the capacity of a wireless cellular system. In particular, the present invention relates to making channel measurements on pilot signals to adaptively configure downlink transmission.

2. Description of Related Art

One of the fundamental parameters constraining multiple access in cellular systems is co-channel interference. Co-channel interference is generally referred to as the level of interference between simultaneous transmissions on the same frequency in, for example, a frequency-division multiple-access (FDMA) scheme, or using the same code symbols in a code-division multiple-access (CDMA) scheme, thus limiting the re-use of frequencies or codes on channels within close spatial proximity to each other. Traditional methods for reducing co-channel interference require that no neighboring cells employ the same frequency channel in adjacent cells. For example, within a hexagonal lattice arrangement of cells, frequency re-use is limited to at most 1/7. Simple re-use schemes reduce the total power of interfering transmissions below the total power of the signal of interest. While co-channel interference can be improved by the use of, for example, directional multi-sectored base station antennae, problems remain. In CDMA systems, channel re-use is not explicitly constrained, although code interference remains a problem. Various “intelligent antennae” schemes attempt to resolve this problem using transmitter and/or receiver arrays for beam-forming or nulling interference. Other schemes include passive systems, which function without any explicit information about the channel and produce a capacity increase based on diversity, and active systems, which employ a reference or “pilot” signal to allow for channel estimation. In any case, these systems are limited because antennae arrays are associated with a single base station or receiver.

### SUMMARY OF THE INVENTION

In the method and apparatus according to the present invention, co-channel interference in a wireless downlink is reduced according to an Adaptive Distributed Transmission (ADT) scheme. The ADT scheme of the present invention provides interference suppression that allows for an increase in the channel re-use fraction, thus increasing the capacity of a cellular network. According to the present invention, a communication channel is continuously monitored by mobile stations which relay measurements back to the corresponding base stations. The base stations communicate with each other over a separate network and determine suitable linear or coherent combinations of messages which are transmitted to the mobile stations such that each mobile station receives its intended message simultaneously from several base stations through constructive interference while messages intended for other mobile stations interfere destructively with each other at the location of the mobile station intended to receive the message. By transmitting messages according to the ADT scheme, the theoretical limit of channel re-use approaches unity, while the practical limit of channel re-use is also improved. With the improvement in channel re-use, the total capacity of the cellular network is also improved.

### BRIEF DESCRIPTION OF THE DRAWINGS

The present invention will become more fully understood from the detailed description given herein below and the accompanying drawings which are given by way of illustration only, and thus are not limitative of the present invention, wherein like reference numerals represent like elements and wherein:

FIG. 1 is a diagram illustrating a cellular network having a plurality of base stations and mobile stations;

FIG. 2 is a graph illustrating base stations monitored by exemplary mobile stations in accordance with various exemplary embodiments of the present invention;

FIG. 3 is a graph illustrating various configurations of base stations monitoring mobile stations and mobile stations monitoring base stations in accordance with various exemplary embodiments of the present invention;

FIG. 4 is a graph illustrating the cumulative probability of error sensitivity for various configurations in accordance with exemplary embodiments of the present invention;

FIG. 5 is a graph illustrating a cumulative probability of interference as signal power for various configurations in accordance various exemplary embodiments of the present invention;

FIG. 6A is a graph illustrating a histogram of the number of mobile stations addressed by a base station in accordance with various exemplary embodiments of the present invention;

FIG. 6B is a graph further illustrating a histogram of the number of mobile stations addressed by a base station in accordance with various exemplary embodiments of the present invention;

FIG. 7A is a graph illustrating the distribution of lattice distances between base stations and mobile stations addressed thereby in accordance with various exemplary embodiments of the present invention; and

FIG. 7B is a graph further illustrating the distribution of lattice distances between base stations and mobile stations addressed thereby in accordance with various exemplary embodiments of the present invention.

### DETAILED DESCRIPTION OF THE DRAWINGS

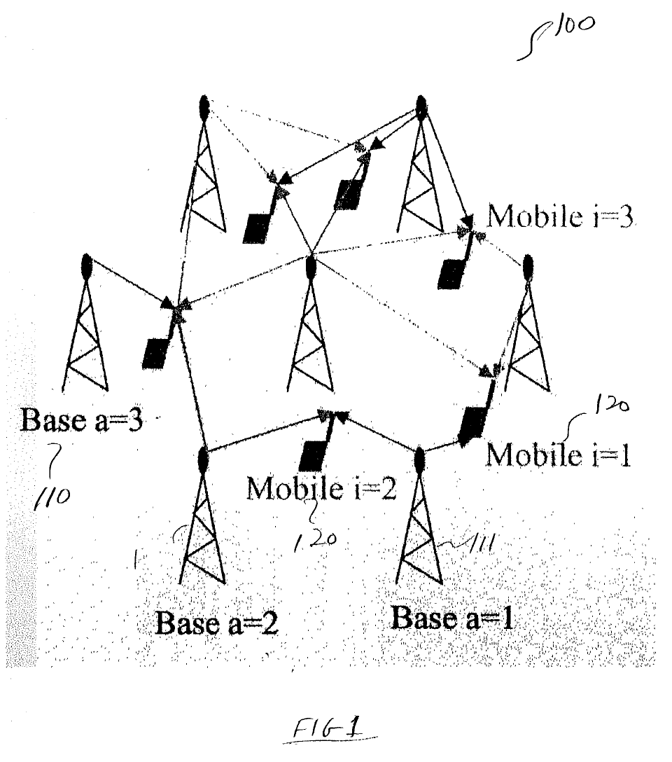

An Adaptive Distributed Transmission (ADT) method and apparatus in accordance with various exemplary embodiments of the present invention such as illustrated in FIG. 1, relies on continuous monitoring of the communication channel 111 by mobile stations 120, which relay their measurements back to the base stations 110. The base stations 110 communicate with each other over a separate network which has been omitted from FIG. 1 for clarity and transmit appropriate linear (coherent) combinations of messages over a wireless interface 111 such that each mobile station 120 receives its intended message simultaneously from several base stations 110 through constructive interference, while signals addressed to other mobile stations 120 interfere destructively at that location. The details of the above steps will be discussed hereinafter.

In principle, an ADT scheme in accordance with the present invention could reach a re-use factor of unity (1), i.e. a mobile/base station ratio equal to one per channel; however, the inevitable error in measuring and “forecasting” the transmission channel properties degrades the signal to interference ratio as the “filling fraction” (mobile/base station channel ratio) gets close to unity.

The ADT method in accordance with various everyday embodiments of the present invention relies on sufficiently slow variation of the communication channel over time. Specifically, the ADT scheme is well suited, provided that the transmission channel is sufficiently constant in time and frequency as characterized by the product τΔω, where τ represents the correlation time of the channel and Δω represents the “flat fading” bandwidth. In accordance with a preferred embodiment of the present invention it is preferable that τΔω be greater than 10³, e.g. τ>10 ms and Δω>100 kHz.

When scaling-up the number of base stations 110 and mobile stations 120, it is preferable to require only local “cooperation” so that the scheme remains viable in a large or even infinite network. Further, given the fundamental limitations imposed by the temporal and spectral coherence of an exemplary channel in multiple scattering environments, it is possible to estimate the capacity and reliability of the ADT system for a triangular lattice of base stations 110 as a function of different mobile/base station channel ratios.

### Adaptive Distributed Transmission Scheme

With reference again to FIG. 1, consider M mobile stations 120 at positions xᵢ (with i=1, . . . , M) in communication with N omnidirectional base stations 110, which form a triangular lattice with vertices rₐ(a=1, . . . , N). All communications share a single channel, either FDMA or CDMA. Let the transmission kernel (the complex gain of propagation between i-th mobile station 120 and a-th base station 110 ) be the complex number:

Kᵢ^{a}(t)=|xᵢ−rₐ|⁻²e^{\sqrt{-1}·k(x}^{ᵢ}^{-r}^{ₐ}^{)+\sqrt{-1}·φ}^{ᵢₐ}^{(t)-η}^{ᵢₐ}^{(t)} (1)

which parameterizes the channel properties of multiple scattering by a random phase φᵢₐ and normally distributed Rayleigh fading exponent ηᵢₐ. These channel properties vary with time and position. For any mobile/base pair at any given time the amplitude and the phase of the transmission kernel can be determined by a measurement of the pilot signal from base as received by the mobile. The absolute phase of Kᵢ^{a} is not essential since it will suffice to know the relative phases of signals arriving at xᵢ from the N base stations 110.

An attempt to transmit messages mᵢ(t) to respective mobile stations 120 by broadcasting different linear superpositions of messages from different base stations 110 can be represented as:

Sₐ=Lₐ¹mᵢ (2)

wherein Sₐ denotes signal transmitted by base a and L is the mixing matrix chosen adaptively in order to minimize cross talk. Cross talk is expressed as:

$$C = {max}_{i} \{ \frac{{\sum }_{j \neq i} {\vert {\sum }_{a} {K}_{i}^{a} ( t ) {L}_{a}^{j} {m}_{j} \vert}^{2}}{{\vert {\sum }_{a} {K}_{i}^{a} ( t ) {L}_{a}^{i} {m}_{i} \vert}^{2}} \} \qquad ( 3 )$$

If L(t)=K⁻¹(t) (where K⁻¹(t) is defined for general M<N as the pseudo-inverse), then the off-diagonal terms in the numerator vanish yielding C=0. The matrix elements Lₐ¹ fix the phase and the power with which base station a transmits message i.

### Effect of Estimation Errors

More realistically, the transmitted signal is given by a mixing matrix L=T(\hat{K}⁻¹) where \hat{K} is the estimated K with the intrinsic error δK(t)=K(t)−\hat{K}(t) arising from the delay Δt between estimation and transmission as well as the inaccuracy of the measurement, and T( ) denotes a truncation where elements of each row that are smaller than certain fixed multiple γ<<1 of the largest element (of the row) are set to zero, then cross talk may be defined as:

$$⟨ {C}_{i} ⟩ = {\vert {m}_{i} \vert}^{- 2} ⟨ {\vert {\sum }_{j \neq i} {\sum }_{a} {K}_{i}^{a} ( t ) {L}_{a}^{j} {m}_{j} \vert}^{2} ⟩ \qquad ( 4 )$$

Assuming statistical independence of messages and exercising the freedom to adjust the relative amplitudes of messages, <mᵢmⱼ^{*}>=δᵢⱼqₜ², the expected ratio of interference to signal power for mobile station i is:

$$⟨ {C}_{i} ⟩ = {q}_{i}^{- 2} {\sum }_{j \neq i} {q}_{j}^{2} ⟨ {\vert {\sum }_{a} δ {K}_{i}^{a} ( t ) {L}_{a}^{j} + {K}_{i}^{a} ( t ) δ {L}_{a}^{j} \vert}^{2} ⟩ \qquad ( 5 )$$

with the two inner terms corresponding to the estimation error (δK) and the L-truncation error δL=T(\hat{K}⁻¹)−\hat{K}⁻¹.

The estimation error (δK) has two components. The first component is the intrinsic prediction error δ_{Δ}Kᵢ^{a}(Δt)due to the delay Δt between the pilot and the transmission, with variance <δ_{Δ}Kᵢ^{a}(Δt)δ_{Δ}Kⱼ^{b}(Δt)*>=δᵢⱼδ^{ab} σ(Δt)<|Kᵢ^{a}|²> where

σ(Δt)≡<|δln Kᵢ^{a}(Δt)|²> (6)

is the variance in forecasting the phase and amplitude of the transmission kernel. The prediction error contributing to the crosstalk is bounded by βᵢσ(Δt) with the “error sensitivity factor”

$${β}_{i} = {q}_{i}^{- 2} {\sum }_{a} {\vert {K}_{i}^{a} \vert}^{2} {( {L}^{+} {q}^{2} L )}_{aa} \qquad ( 7 )$$

where L⁺ is the adjoint of L and (L⁺q²L)ₐₐ denotes the aa element of (L⁺q²L) matrix.

The second component of the estimation error δK is the truncation error due to a finite signal-to-noise ratio, which places a lower bound on the strength of a detectable pilot. A given mobile station 120 can only monitor signals from base stations 110 which are not too far away. Therefore, the estimated kernel \hat{K} has a finite number of non-zero entries in each row. In simulations it may be preferable to choose a cutoff number less than 12 so that each mobile station 120 only monitors base stations 110 in the nearest and next-nearest coordination “shells”. The extended system limit is where the total number of both mobile stations 120 and base stations 110 goes to infinity (N,M →∞) while keeping a constant “filling fraction”=0 or re-use ratio v=M/N <1. It can be demonstrated that interference remains bounded.

The effectiveness of the ADT scheme in accordance with the present invention depends in part on three factors: (1) the accuracy of adaptation given that the transmission kernel depends both on time and on frequency; (2) the regularity/singularity of the matrix K given that large eigenvalues of K⁻¹ tend to amplify estimation errors; and (3) the matrix L that specifies the linear superposition of messages to be broadcast by each base station should not involve messages whose proper addressee is too far away. These factors will be discussed hereinafter.

### Error Sensitivity, Locality and Cross-talk in an Exemplary ADT Scheme

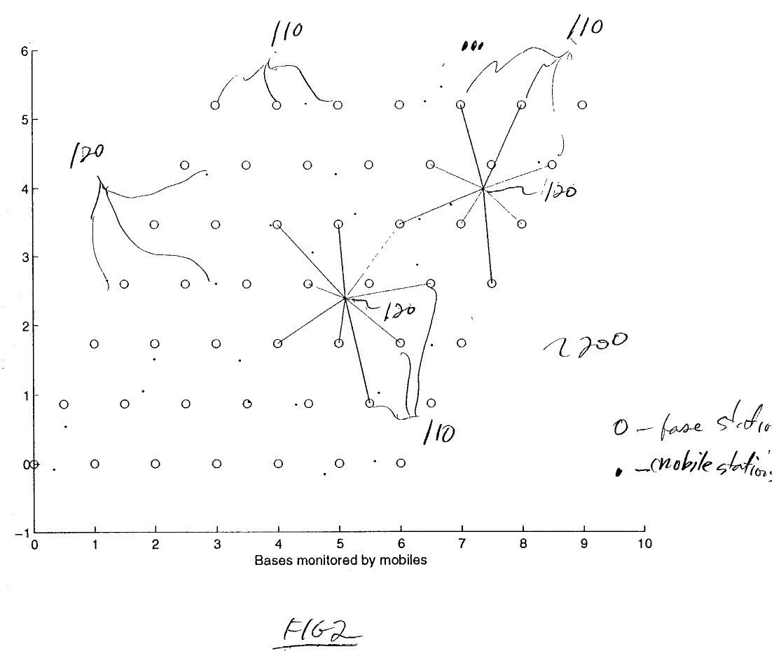

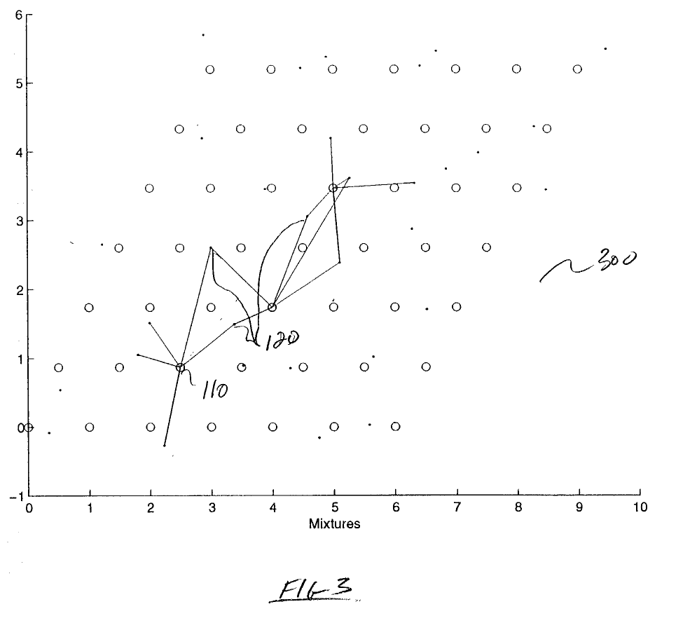

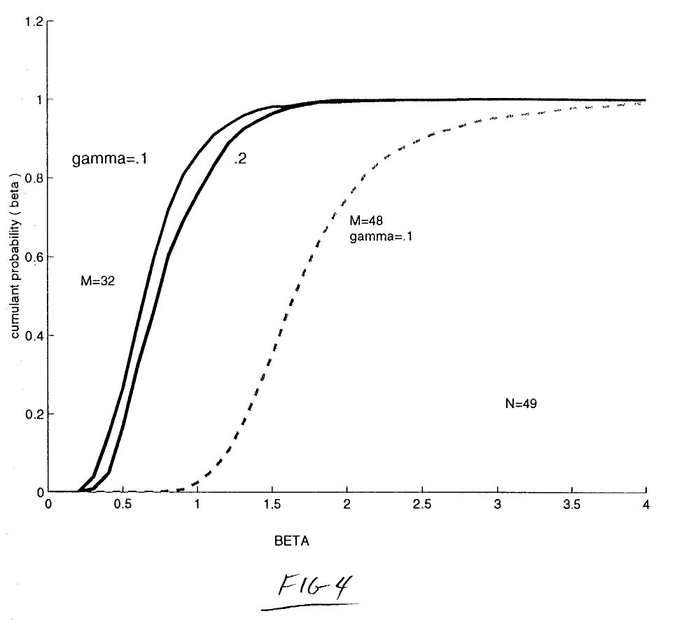

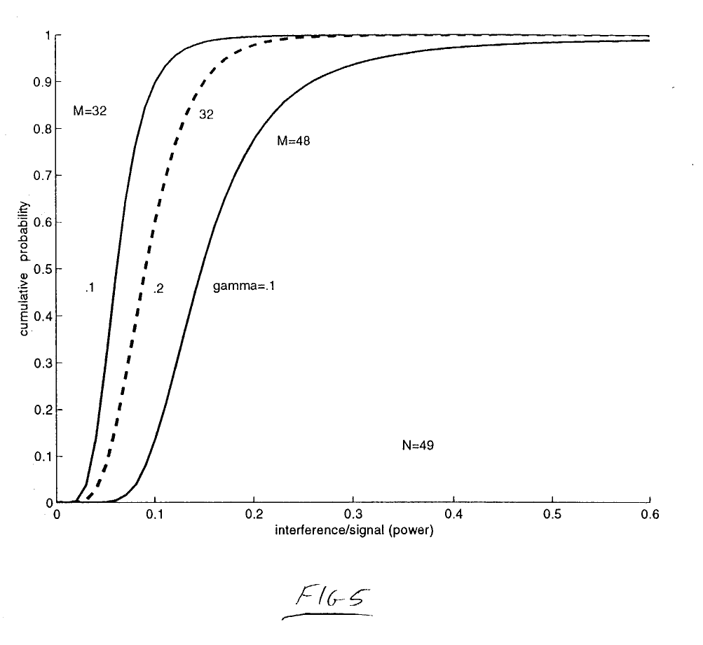

Sensitivity to estimation error depends in part on the eigenvalues of (KK⁺)⁻¹. For stability reasons, it is preferred that matrix (KK⁺)⁻¹ is non-singular. The likelihood of non-singularity is improved when mobile stations 120 do not cluster spatially. Such non-singularity may be confirmed numerically in a triangular lattice of N=49 base stations with a periodic boundary condition such as can be seen for example in FIGS. 2 and 3 by generating a uniform distribution of M mobile stations with the restriction that there should be no more than one mobile station 120 per hexagonal cell. In FIGS. 4 and 5, the cumulative distribution of the error sensitivity factors βᵢ, for example as defined by Equation 7, is shown. It should be further noted that the sensitivity factors are of o(1) which implies, at worst, very modest error amplification. On the other hand, in an unrestricted Poisson ensemble, there will be a finite probability of having a local cluster of m mobile stations 120 communicating with n<m base stations 110 resulting in a singular matrix. Such clustering of mobile stations 120, however, is a problem for any scheme and may be alleviated in part by assigning different nearby mobile stations 120 to different channels.

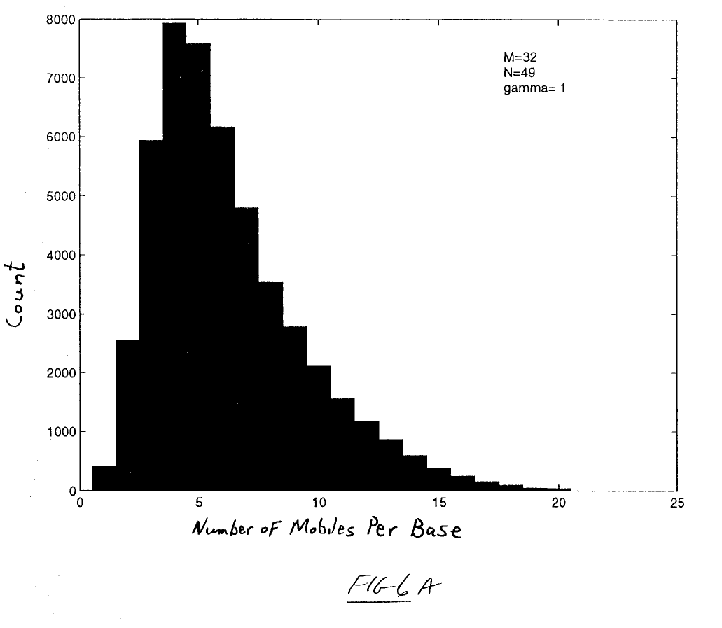

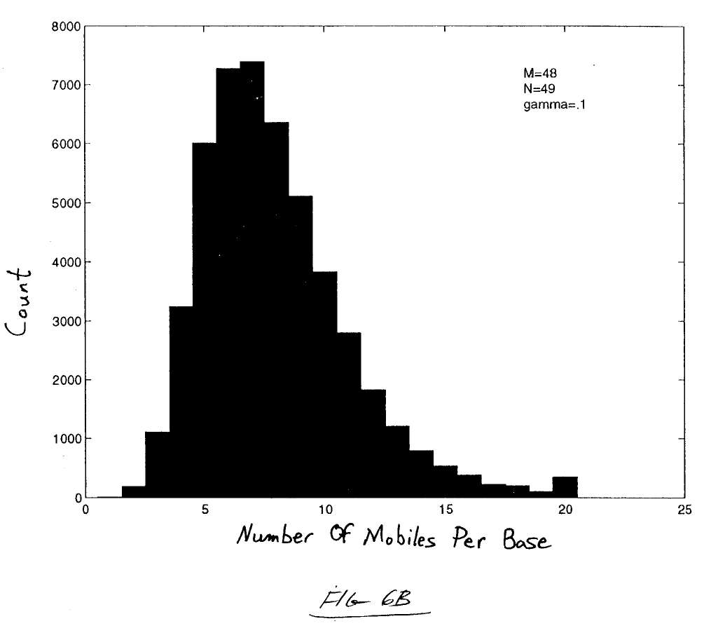

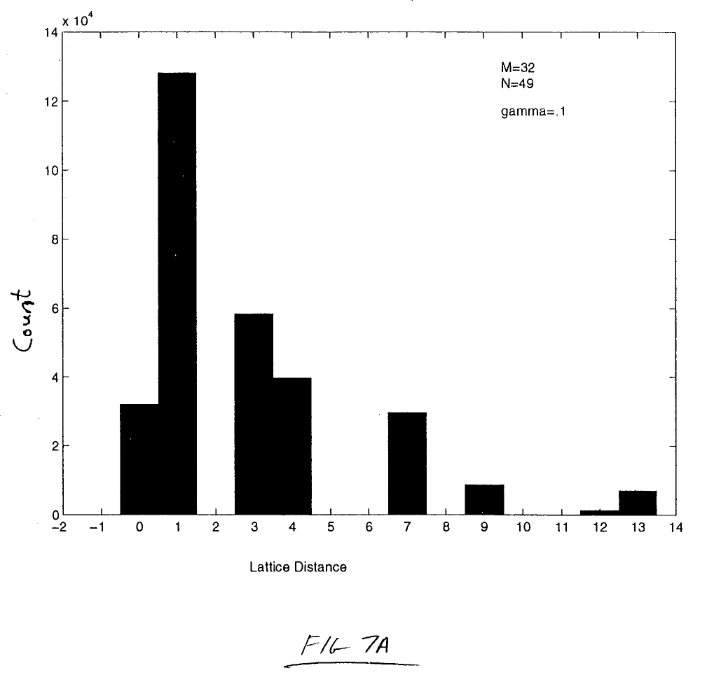

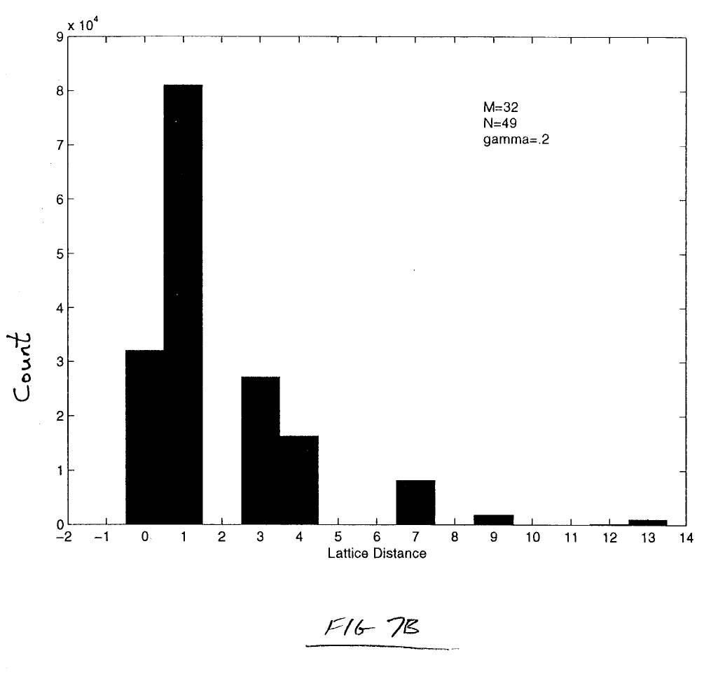

With regard to locality, even though only a finite number of base stations 110 are active in communicating with a given mobile station 120 as shown in FIG. 2 because of the truncation of \hat{K}—there is no immediate guarantee that the linear superpositions of messages broadcast by a given base station 110 as determined by \hat{K}⁻¹, are localized, i.e. do not involve admixtures of messages from mobile stations 120 far away. The inverse of a sparse matrix \hat{K} is not by itself sparse and requires an explicit truncation, which is imposed by limiting the dynamic range of the linear superposition. By introducing additional error into the mixture matrix L, truncation may have an adverse effect on the residual cross-talk. Assuming that truncation is the dominant source of error, the cross-talk distribution can be estimated. The value of the truncation threshold γ is sought such that cross-talk is suppressed by, for example, ˜10 dB. The assumption concerning truncation error dominance is generally correct provided that the contribution of the estimation and measurement errors are small, for example <−10 dB FIG. 5 shows the cumulative distribution of C (see Equation 3) obtained via Monte-Carlo simulation of random mobile station 120 configurations with single occupancy constraint on the N=49 lattice for different truncation parameters γ at different re-use factors M/N. The distribution of numbers of messages per base station 110 and the distances in the triangular lattice coordinates p²+pq+q² in which p,q=(1,0) corresponds to a nearest neighbor, (1,1) to the next-nearest-neighbor and the like are shown in histograms by FIGS. 6A and 6B and FIGS. 7A and 7B. It will be evident that decreasing γ and thus increasing the dynamic range, de-localizes the mixtures, which improves the signal-to-interference ratio.

### Fundamental Limit on the Accuracy of Adaptation

The accuracy at adaptation of an ADT scheme in accordance with the present invention is bounded basically because both the time and bandwidth available for the measurement of pilot signals are limited. Assume for simplicity that channel randomness involves only the phase, although the discussion can be directly extended to include Rayleigh fading parametrized by a random η as shown in Equation 1. Within the phase-randomness-only model:

$$⟨ δ {K}_{i}^{a} δ {\overline{K}}_{j}^{b} ⟩ \approx \frac{1}{2} {δ}_{ji} {δ}^{ab} {\vert {K}_{i}^{a} \vert}^{2} {⟨ \{ {ϕ}_{ia} ( Δ t ) ) - {ϕ}_{ia} ( 0 ) - δ {ϕ}_{ia} \}}^{2} ⟩ \qquad ( 8 )$$

where φᵢₐ(Δt)−φᵢₐ₍0) is the prediction error, δφᵢₐ is the initial measurement error, and \overline{K} is the complex conjugate of K. The prediction error depends on the scattering properties of the environment. Three regimes may be distinguished:

1) the diffusive regime <e^{iφ(t)}e^{-iφ(0)}>=e^{-2t/τ} or

<{φ(t)−φ(0)}²>=τ⁻¹t (9)

where the phase change is due to rapidly and randomly changing weak scatterers and τ is the correlation time;

2) the phase drift regime

<{φ(t)−φ(0)}²>=(τ⁻¹t)² (10)

where large changes of the phase occur in a coherent manner—on a much longer time scale this regime may cross over to diffusion; and

3) the phase order regime where (e^{iφ(ta)}e^{-iφ(0)}>≈cnst at long times and the phase fluctuates close to an average value with the variance obeying Equation 10 at short times.

Indoor environments are typically characterized as regimes 2-3, while a mobile station moving on the street in Manhattan is likely to be characterized as regime 1.

Prediction or forward extrapolation error arises from inherent delays between measurement and transmission, which, in the worst case of phase diffusion, goes to Δt/τ. In addition, there is the intrinsic error of measurement which is proportional to the spectral density of noise, n(ν), and inversely proportional to the measurement time: n(ν)/Δtₘ. Hence,

$$⟨ Δ {φ}^{2} ⟩ = \frac{Δ t}{τ} + {\int }_{Δ {t}_{m}^{- 1}}^{∞} ⅆ v n ( v ) \qquad ( 11 )$$

Since the delay cannot be shorter than the measurement time Δtₘ. there is a minimum <ΔΦ²> for Δt=Δtₘ=\sqrt{τn(ν)} with <ΔΦ²>˜2\sqrt{n(ν)/τ}, which minimizes Equation 11 over measurement times.

In a simple scheme of transmission where a pilot is alternated with a message, the pilot should not have too-long a duty cycle α_{c} so that Δtₘ=α_{c}Δt with α_{c}<<1. To estimate the spectral density of the measurement noise n(ν) it can be assumed that the equal time fluctuations <δφ²(t)> are dominated by interference in the system and thus determined by the characteristic interference-to-signal ratio say for example, 10 dB. Since <δφ²(t)>=n(ν)ν_{ch} we estimate n(ν)=0.1/ν_{ch} where ν_{ch} is the communication channel's bandwidth. Hence Δtν_{ch}=\sqrt{τν_{ch}α_{c}⁻¹/10} and <ΔΦ²>˜2/\sqrt{10α_{c}τν_{ch}}. Maintaining <ΔΦ²>0.1 as required by self-consistency requires that τν_{ch}>400 assuming α_{c}=0.2.

Another relatively more strict limit is preferably by the necessity to transmit N_{B} distinct simultaneous pilots which requires bandwidth of at least N_{B}/Δtₘ or alternatively imposes Δtₘν_{ch}>N_{B}. It should be noted that a separate and identifiable pilot from each base station is needed and a pattern of pilots must be assigned on a super-lattice of an appropriately high order >7, perhaps 13 or 19 depending on how weak a base station is included in the superposition. The measurement uncertainty N_{B}⁻¹ν_{ch}n(ν) then becomes negligible and prediction error dominates so that Δt/τ=N_{B}/α_{c}τν_{ch}<0.1 which implies τν_{ch}>10N_{B}α_{c}⁻¹=500. Such a scenario could be achieved with a plausible coherence time of τ=10 ms and channel bandwidth ν_{ch}=50 kHz. On the other hand, the maximal channel bandwidth is limited by the requirement that the phase fluctuations Δφ remain coherent over the frequency range

<{φ(t,ν₀+ν)−φ(t,ν₀)}²>=(ν/Δω)₂ (12)

so that ν_{ch}<0.3Δω. Thus, the adaptive scheme in accordance with the present invention depends on the fundamental propagation characteristic τΔω being sufficiently large, i.e. τΔω>10³.

The present invention appreciates that replacing a unique base station-mobile station link by a distributed link, i.e. link where a message to one mobile station 120 is broadcast by a number of nearby base stations 110 and each base station 110 transmits concurrently to a number of mobile stations 120 over the same channel, can lead to an increase in the channel re-use fraction when channel re-use is defined as a ratio of the number of receivers to transmitters, i.e. mobile/base station utilizing the same channel. Interference reduction is achieved by adapting the relative amplitudes and phases of transmitted messages to the transmission kernel. It requires base stations 110 to transmit identifiable pilot signals, for mobile stations 120 to measure them, and to transmit the result back to base stations 110 over associated uplinks, and for base stations 110 to share this information over a separate network. In a simulation of randomly placed mobile stations in a two-dimensional array of base station antennae 111, a ⅔ channel re-use with 10 dB signal-to-interference ratio was found to be feasible, and favorably compares against the 1/7 re-use in an FDMA scheme. The feasibility of the adaptive, or active, scheme in accordance with the present invention rests on the coherence properties of the channel.

The invention being thus described, it will be obvious that the same may be varied in many ways. For example, the channel re-use ratio could be greater or less than 2/3 depending on coherence properties of the channel including factors such as operational environment and quality requirements. Similarly, the signal-to-interference ratio and other such parameters may also be varied. Such variations are not to be regarded as a departure from the spirit and scope of the invention, and all such modifications as would be obvious to one skilled in the art are intended to be included within the scope of the following claims.

What is claimed:

1. A method for improving channel re-use in a wireless network, comprising:
transmitting a pilot signal from a base station, the pilot signal being identifiable with the base station;
receiving, from one or more mobile stations at the base station on an uplink channel, a measured one or more parameters associated with at least one pilot signal; and
sharing the measured one or more parameters.

2. The method of claim 1, wherein the measured one or more parameters are shared over a second network operating independent from the wireless network.

3. The method of claim 2, wherein the measured one or more parameters are shared among a plurality of base stations.

4. The method of claim 1, wherein the wireless network is one of a CDMA and a FDMA network.

5. The method of claim 1, further comprising:
formulating co-channel transmissions using the measured one or more parameters; and
transmitting the co-channel transmissions from the base station such that at least two mobile stations receive respective ones of the co-channel transmissions on a same channel.

6. The method of claim 5, wherein the formulating step formulates co-channel transmissions based on a mixing matrix determined to minimize cross talk.

7. The method of claim 6, wherein the mixing matrix includes an estimation error.

8. A method for improving channel re-use in a wireless network, comprising:
receiving from one or more base stations, a corresponding one or more pilot signals, each of the pilot signals identifiable with a corresponding one of the base stations;
measuring one or more parameters associated with the pilot signals;
transmitting the measured one or more parameters associated with the pilot signals to at least one of the base stations on an uplink channel; and
receiving co-channel transmissions formulated using the measured one or more parameters, such that at least one other mobile station receives respective ones of the co-channel transmissions on a same channel.

9. The method of claim 8, wherein the network is one of a CDMA and a FDMA network.
